(19) United States
(12) Patent Application Publication
(10) Pub. No.: US 2018/0376182 A1
(43) Pub. Date: Dec. 27, 2018

(54) IP BASED VIDEO TRANSMISSION DEVICE AND BROADCAST SYSTEM

(71) Applicant: MEDIA LINKS CO., LTD., Kawasaki-shi, Kanagawa (JP)

(72) Inventors: Masaaki KOJIMA, Tokyo (JP); Hiroyuki TERASAKI, Tokyo (JP); Takeharu SHIMIZU, Tokyo (JP); Yukiyo ASAKURA, Tokyo (JP); Sho HONGO, Kawasaki-shi (JP); Kazunori NAKAMURA, Kawasaki-shi (JP)

(73) Assignee: MEDIA LINKS CO., LTD., Kawasaki-shi, Kanagawa (JP)

(21) Appl. No.: 16/063,332

(22) PCT Filed: Dec. 18, 2015
(86) PCT No.: PCT/JP2015/006330

§ 371 Date: Jun. 18, 2018

(51) Int. Cl. H04N 21/24; H04N 21/2343; H04N 21/643; H04N 19/85

(52) U.S. Cl. CPC H04N 21/2407; H04N 19/85; H04N 21/64322; H04N 21/2343

(57) ABSTRACT

A broadcasting system of the present invention includes a video transmission device that receives uncompressed video signals to generate IP packet streams having uncompressed video data, and compresses uncompressed signals to IP packet streams having compressed video data, a video delivering system that delivers IP packet streams having uncompressed video data for high quality video, and delivers IP packet streams having compressed video data for monitor to a monitoring system, and the monitoring system that selects and displays IP packet streams to be monitored among the IP packet streams received from the video transmission device.

### Technical Field

The present invention relates to a video transmitter and a monitoring system for monitoring videos, and in particular, to a video transmitter and a monitoring system for monitoring videos in an IP-based broadcasting system.

### Background Art

A broadcasting system for imaging, editing and delivering a plurality of types of videos requires a video delivering system for selecting and switching video signals from an external network, a recording studio or the like and for delivering the selected video signals, and a monitoring system for checking whether the video delivering system is delivering appropriate videos. Hereinafter, a video signal refers to an uncompressed video signal such as a 3G-SDI signal specified in the SMPTE 424M, an HD-SDI signal specified in the SMPTE 292M, or an SD-SDI signal specified in the SMPTE 259M.

The monitoring system in the broadcasting system has functions for receiving from respective video sources including the external network, the recording studio and the like, selecting and displaying video signals to be checked. The function for displaying is usually implemented in a plurality of monitors.

The purpose of the monitoring system is to check whether the video signals are delivered correctly from the video delivering system, and not to check video quality. Therefore, it only requires to check video contents, and does not require higher definition videos. In addition, delay times between which videos are delivered by the video delivering system and videos are displayed on the monitor is acceptable to about a few milliseconds.

FIG. 1 is a block diagram showing an exemplary structure of a broadcasting system 1 according to the prior art. In the broadcasting system 1 according to the prior art illustrated in FIG. 1, video signals from an external network 101 are converted into HD-SDI signals 1011 that are electrical signals by a photoelectric converter 1013 via an optical fiber 1012, and the converted HD-SDI signals are inputted into a video delivering system 11. In the video delivering system 11, the HD-SDI signals 1011 are distributed into a matrix switcher 110 and a monitoring system 12 by a distributor 111. HD-SDI signals 1021 from a recording studio and HD-SDI signals 1031 from an editing system 103 are inputted into the video delivering system 11, and distributed into the matrix switcher 110 and the monitoring system 12 by distributors 112 and 113 respectively. In the video delivering system 11, the matrix switcher 110 selects HD-SDI signals 1101, 1102 and 1103 to be outputted to a sending system 104, an archiving system 105 and an editing system 106 among the HD-SDI signals 1011, 1021 and 1031 respectively.

On the other hand, in the monitoring system 12, a dedicated matrix switcher 120 selects video signals to be displayed on monitors 121 to 128 among the video signals 1011, 1021 and 1031 respectively.

Since all signals processed in the video delivering system 11 are not necessarily to be displayed on the monitors in the monitoring system 12, the matrix switcher 120 in the monitoring system 12 is typically smaller than the matrix switcher 110 in the video delivering system 11.

The broadcasting system according to the prior art illustrated in FIG. 1 is a system based on transmission of video signals on coaxial cables, and uses expensive matrix switchers with simple structure and requires high costs for setting cables, which leads to high costs for introduction.

On the other hand, with recent advances in IT technology, broadcasting systems are transitioning to an Internet Protocol (IP) based systems. This trend is described in, for example, “Broadcasting Facilities and Operations”, Journal of the Institute of Image Information and Television Engineers, Vol. 67, No. 5 (2013). The IP-based systems are also coming to be used in a video delivering systems. These IP-based broadcasting systems IP-packetize video signals and transmit the IP packets using the Real-Time Transport Protocol (RTP). A sequence of IP-packetized video signals are referred to as an IP packet stream herein. That is, one IP packet stream is generated by IP-packetizing one video signal.

FIG. 2 is a block diagram showing an exemplary structure of a broadcast system 2 using an IP-based video delivering system. The broadcast system 2 illustrated FIG. 2 includes an IP-based video delivering system 21, an external IP network 201, a recording studio 202, an editing system 203, a sending system 204, an archiving system 205, an editing system 206, and an IP-based monitoring system 22. The external IP network 201, the recording studio 202 and the editing system 203 output IP packet streams to the IP-based video delivering system 21. The sending system 204, the archiving system 205 and the editing system 206 receive IP packet streams from the IP-based video delivering system 21. The IP-based monitoring system 22 receives IP packet streams from the IP-based video delivering system 21.

The IP-based video delivering system 21 includes an L2/L3 switch 210 configured to perform switching on an IP layer or MAC (Media Access Control) sublayer. The IP-based monitoring system 22 includes an L2/L3 switch 220, depacketizers 2221 to 2228 each configured to convert IP packet streams having uncompressed videos from the L2/L3 switch 210 into HD-SDI signals, and monitors 221 to 228 each configured to display the video signals from the depacketizers 2221 to 2228. The recording studio 202 includes a packetizer 2022 configured to convert the HD-SDI signals into the IP packet streams. The editing system 203 includes a packetizer 2032 configured to convert the HD-SDI signals into the IP packet streams. The sending system 204 includes a depacketizer 2042 configured to convert the IP packet streams into the HD-SDI signals. The archiving system 205 includes a depacketizer 2052 configured to convert the IP packet streams into the HD-SDI signals. The editing system 206 includes a depacketizer 2062 configured to convert the IP packet streams into the HD-SDI signals. The black-shaded squares adjacent to arrows represent IP packet streams having uncompressed videos in FIG. 3.

The IP packets converted by the packetizers 2022 and 2032 from the HD-SDI signals, and the IP packets to be converted by the depacketizers 2221 to 2228, 2042, 2052 and 2062 into the HD-SDI signals are in a packet format specified in the SMPTE2022-6.

A device for IP-packetizing and IP-depacketizing between the HD-SDI signals and the IP packets specified in the SMPTE2022-6 have been already commercialized as of 2013, such as the MD8000 from MEDIA LINKS Co., Ltd.

In the broadcasting system illustrated in FIG. 2, IP packet streams 2012 having uncompressed videos inputted from the external IP network 201 via a 10 GbE (10 Gigabit Ethernet (registered trademark)) 2011 are inputted into the L2/L3 switch 210 in the IP-based video delivering system 21. HD-SDI signals 2020 in the recording studio 202 are converted into IP packet streams 2023 by the packetizer 2022, and the converted IP packet streams are inputted into the L2/L3 switch 210 via a 10 GbE 2021. HD-SDI signals 2030 in the editing system 203 are converted into IP packet streams 2033 by the packetizer 2032, and the converted IP packet streams are inputted into the L2/L3 switch 210 via a 10 GbE 2031. The L2/L3 switch 210 selects IP packets to be outputted to the sending system 204, the archiving system 205, the editing system 206 and the IP-based monitoring system 22 among the IP packet streams inputted from the 10 GbEs 2011, 2021 and 2031 respectively, and outputs the selected IP packets to 10 GbEs 2101 to 2106 respectively. In the sending system 204, the depacktizer 2042 converts IP packet streams 2111 received by a 10 GbE 2101 into HD-SDI signals 2041 for use. In the archiving system 205, the depacktizer 2052 converts IP packet streams 2112 received by a 10 GbE 2102 into HD-SDI signals 2051 for use. In the editing system 206, the depacktizer 2062 converts IP packet streams 2113 received by a 10 GbE 2103 into HD-SDI signals 2061 for use.

In the IP-based monitoring system 22, the L2/L3 switch 220 selects IP packets having videos to be displayed on the monitors 221 to 228 among IP packet streams 2114 to 2116 inputted from 10 GbEs 2104 to 2106 respectively, and output the selected video IP packets to 10 GbEs 2201 to 2208 respectively. IP packet streams received via the 10 GbEs 2201 to 2208 are converted by the depacktizers 2221 to 2228 into HD-SDI signals 2291 to 2298 respectively, and the converted HD-SDI signals are displayed on the monitors 221 to 228 respectively.

As described above, the broadcasting system illustrated in FIG. 2 has the same functions as those in the broadcasting system according to the prior art illustrated in FIG. 1. Further, since the broadcasting system illustrated in FIG. 2 uses the Ethernet (registered trademark) and L2/L3 switch techniques, it is easy to extend distances between systems, and the number of cables and cabling costs can be reduced, compared to the system based on transmission on coaxial cables illustrated in FIG. 1.

However, the broadcasting system illustrated in FIG. 2 uses 10 GbEs for all interfaces for delivering videos and for monitoring, except for coaxial cables inside the system. Because HD-SDI signals having uncompressed video signals have high bit rate (1.485 Gbps), and IP packet streams that are IP-packetized from the HD-SDIs cannot be transferred with 1 GbE. Therefore, the L2/L3 switches 210 and 220 need to have multiple 1 GbE ports, and thus it requires to use high cost switches. In addition, each monitor needs a depacketizer, and the depacketizer also needs to support 10 GbE, which lead to high costs.

The monitoring system only requires to check video contents, and does not require higher definition. In addition, video delay times are acceptable to about a few milliseconds. Accordingly, in order to solve the above-mentioned problem, an objective of the present invention is to provide an inexpensive monitoring system by inputting into a video delivering system, IP packet streams having uncompressed videos and IP packet streams having videos that are compressed from the uncompressed videos simultaneously, and providing IP packet streams having compressed videos with low bit rate to the monitoring system. Herein, bit rates for IP packet streams having compressed videos depend on compression techniques used for compression. For example, bit rates from about 75 Mbps to about 400 Mbps are typically employed as bit rates after compression for HD-SDI signals in the JPEG2000 scheme.

### SUMMARY OF INVENTION

In order to achieve the above-mentioned objective, a first aspect of the present invention is characterized in that a video transmitter comprises a receiver configured to receive uncompressed video signals, a signal compressor configured to compress the uncompressed video signals to generate compressed video data, and an IP-converter configured to IP-packetize the uncompressed video signals and the compressed video data and transmit a plurality of IP packet streams to a network, wherein the IP packet streams having uncompressed video data and the IP packet streams having compressed video data are generated from the uncompressed video signals, and the IP packet streams having the uncompressed video data and the IP packet streams having the compressed video data are transmitted to the network.

Further, a second aspect of the present invention is characterized in that the video transmitter further comprises a signal converter configured to receive from a network and convert into uncompressed video signals, IP packet streams having uncompressed video data, a transmitter configured to transmit the uncompressed video signals, and a signal compressor configured to convert the uncompressed video signals into IP packet streams having compressed video data, wherein the uncompressed video signals and the IP packet streams having the compressed video data are generated from the IP packet streams having the uncompressed video data, the uncompressed video signals are transmitted, and the IP packet streams having the compressed video data are transmitted to the network.

According to the present invention, a monitoring system with low cost using IP packet streams having compressed videos with lower bit rate than that for uncompressed videos can be achieved. Further, it can use twist-pair cables instead of optical-fibers, thereby reducing cable costs and wiring costs.

### BRIEF DESCRIPTION OF DRAWINGS

FIG. 1 is a block diagram showing a broadcasting system using coaxial cables according to the prior art;

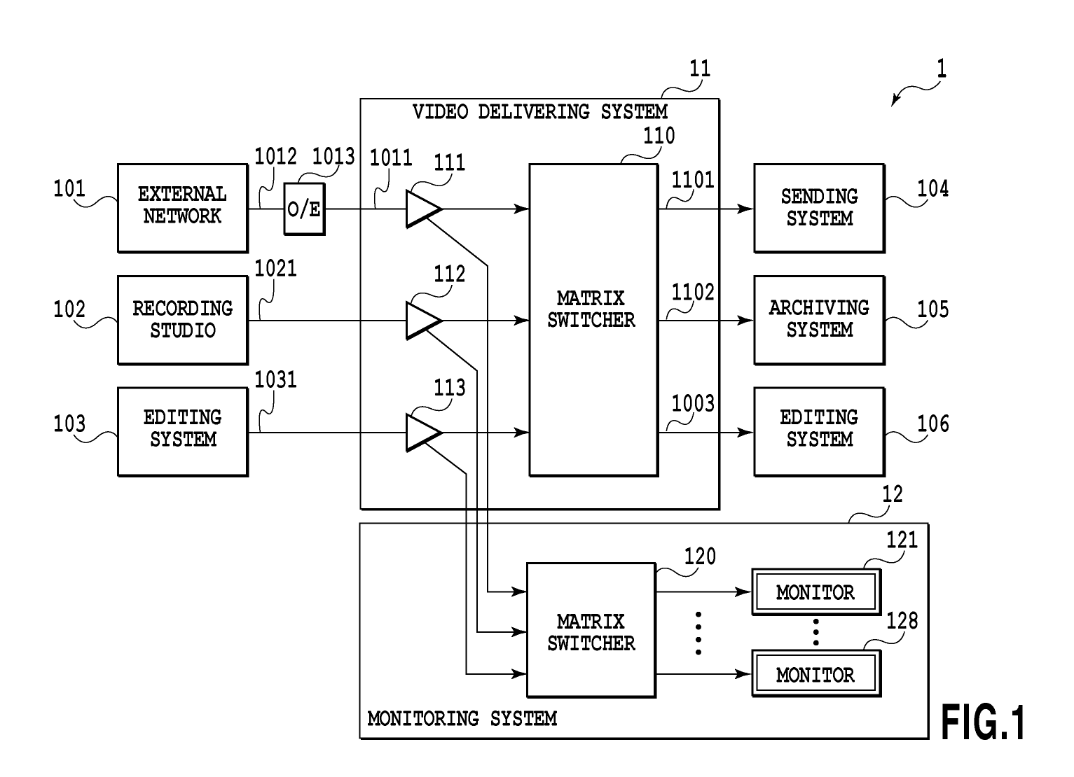

FIG. 2 is a block diagram showing a broadcast system in which a monitoring system according to the prior art is used for an IP-based video delivering system;

FIG. 3 is a block diagram showing an IP based broadcasting system using a monitoring system according to one embodiment of the present invention;

FIG. 4 is a diagram showing a packet format specified in the SMPTE2022-6;

FIG. 5 is a diagram showing a packet format specified in the SMPTE2022-2;

FIG. 6 is a block diagram showing an exemplary structure of a video transmitter used in the monitoring system illustrated in FIG. 3; and

FIG. 7 is a block diagram showing an exemplary structure of a video transmitter used in the monitoring system illustrated in FIG. 3.

### DETAILED DESCRIPTION OF INVENTION

Hereinafter, embodiments of the present invention are described in detail in reference to the attached drawings.

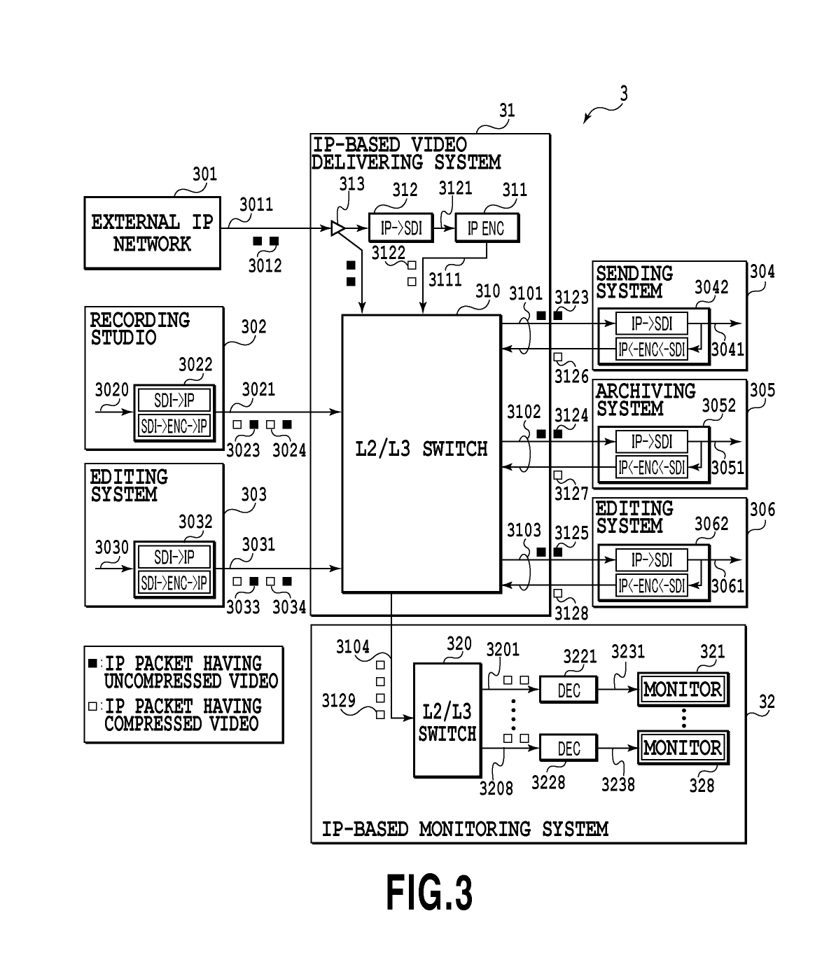

FIG. 3 is a block diagram showing an exemplary structure of an IP based broadcasting system using a monitoring system according to one embodiment of the present invention. The broadcast system 3 illustrated in FIG. 3 includes an IP-based video delivering system 31, an external IP network 301, a recording studio 302, an editing system 303, a sending system 304, an archiving system 305, an editing system 306, and an IP-based monitoring system 32. The external IP network 301, the recording studio 302 and the editing system 303 output IP packet streams to the IP-based video delivering system 31. The sending system 304, the archiving system 305 and the editing system 306 receive the IP packet streams from the IP-based video delivering system 31. The IP-based monitoring system 32 receives IP packet streams from the IP-based video delivering system 31.

The IP-based video delivering system 31 includes an L2/L3 switch 310 configured to perform switching on an IP layer or a MAC sublayer, a depacketizer 312 configured to receive from the external IP network 301 and convert into HD-SDI signals 3121, IP packet streams 3012 compliant with the SMPTE2022-6, and an encoder 311 configured to encode the HD-SDI signals 3121 outputted from the depacketizer 312 according to the JPEG2000 scheme and output IP packet streams having compressed videos compliant with the SMPTE2022-2 to a 1 GbE 3111. With respect to a device having functions comprised in the depacketizer 312 and functions comprised in the encoder 311, a plurality of devices have been already commercialized as of 2013, such as the MD8000 from MEDIA LINKS Co., Ltd.

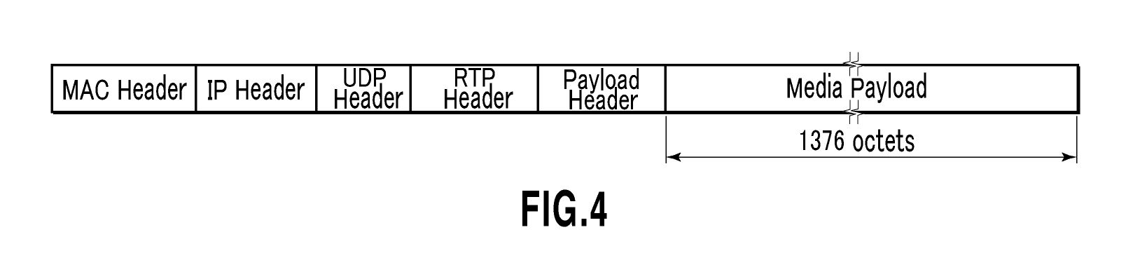

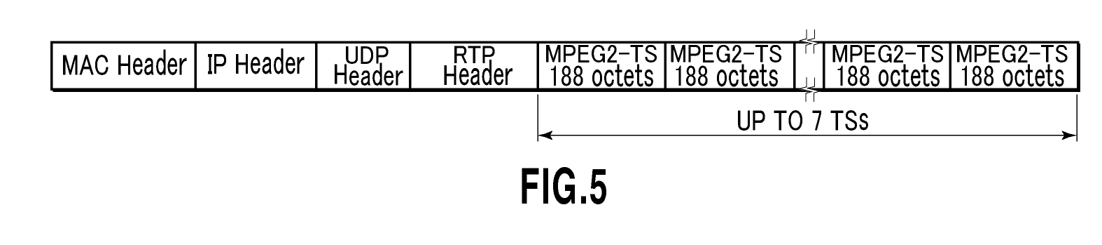

The SMPTE2022-2 corresponds to specifications for IP-packetizing streams having compressed videos in MPEG-TS signals. FIG. 4 shows a packet format specified in the SMPTE2022-6. Uncompressed videos are transmitted in a field “Media Payload” specified for an IP packet illustrated in FIG. 4. The “Media Payload” is a field with fixed 1376 length octets. Further, FIG. 5 shows a packet format specified in the SMPTE2022-2. Compressed videos are transmitted in a field “MPEG2-TS Payload” specified for an IP packet illustrated in FIG. 5. This field can contain up to seven MPEG2-TS signals.

With reference to FIG. 3 again, the recording studio 302 includes a video transmitter 3022 configured to generate from HD-SDI signals 3020 and transmit to a 10 GbE 3021, IP packet streams 3023 having uncompressed videos compliant with the MPTE2022-6 and IP packet streams 3024 having compressed video compliant with the MPTE2022-2. The editing system 303 also includes a video transmitter 3032 configured to generate from HD-SDI signals 3030 and transmit to a 10 GbE 3031, IP packet streams 3033 having uncompressed videos and IP packet streams 3034 having compressed videos.

The IP-based monitoring system 32 includes an L2/L3 switch 320 configured receive and select the IP packet streams inputted from the L2/L3 switch 310, decoders 3221 to 3228 each configured to decode and convert into HD-SDI signals, video data in the IP packet streams, that are outputted from the L2/L3 switch 320, having compressed videos compliant with the MPTE2022-2, and monitors 321 to 328 each configured to display the video signals outputted from the decoders 3221 to 3228.

The sending system 304 includes a video transmitter 3042 having a depacketizing function for receiving from a 10 GbE 3101 and converting into HD-SDI signals 3041, IP packet streams 3123 compliant with the SMPTE2022-6, and a compressing function for generating from the converted HD-SDI signals 3041 and transmitting to the 10 GbE 3101, IP packet streams 3126 having compressed videos compliant with the MPTE2022-2. The archiving system 305 includes a video transmitter 3052 having a depacketizing function for receiving from a 10 GbE 3102 and converting into HD-SDI signals 3051, IP packet streams 3124 compliant with the SMPTE2022-6, and a compressing function for generating from the converted HD-SDI signals 3051 and transmitting to the 10 GbE 3102, IP packet streams 3127 having compressed videos compliant with the MPTE2022-2.

The editing system 306 includes a video transmitter 3062 having a depacketizing function for receiving from a 10 GbE 3103 and converting into HD-SDI signals 3306, IP packet streams 3125 compliant with the SMPTE2022-6, and a compressing function for generating from the converted HD-SDI signals 3061 and transmitting to the 10 GbE 3103, IP packet streams 3128 having compressed videos compliant with the MPTE2022-2.

The black-shaded squares adjacent to the arrows represent IP packet streams having uncompressed videos, and the white-shaded squares adjacent to the arrows represent IP packet streams having compressed videos in FIG. 3.

In the IP-based video delivering system 31, the IP packet streams 3012 having uncompressed videos inputted from the external IP network 301 via the 10 GbE 3011 are inputted into the L2/L3 switch 310 and the depacketizer 312 through an optical splitter 313. The depacketizer 312 converts the inputted IP packet streams 3012 having uncompressed videos into the HD-SDI signals 3121 and transmits the converted HD-SDI signals to the encoder 311. The encoder 311 compresses videos in the HD-SDI signals 3121 to 100 Mbps signals according to the JPEG2000 encoding scheme to generate and output to the L2/L3 switch 310 via the 1 GbE 3111, IP packet streams 3122 compliant with the SMPTE2022-2. That is, the L2/L3 switch 310 receives both of the IP packet streams 3012 having uncompressed videos and the IP packet streams 3122 having compressed videos.

The video transmitter 3022 in the recording studio 302 converts the HD-SDI signals 3020 into the IP packet streams 3023 having uncompressed videos compliant with the SMPTE2022-6, and transmits the converted IP packet streams to the L2/L3 switch 310 via the 10 GbE 3021. In conjunction with that, the video transmitter 3022 compresses videos in the HD-SDI signals 3020 to 100 Mbps signals according to the JPEG2000 encoding scheme, converts the compressed signals into the IP packet streams 3024 having compressed videos compliant with the SMPTE2022-2, and transmits the converted IP packet streams the to the L2/L3 switch 310 via the 1 GbE 3021. That is, in the same way as the case of receiving the videos from the external IP network, the L2/L3 switch 310 receives both of the IP packet streams 3023 having uncompressed videos and the IP packet streams 3024 having compressed signals with 100 Mbps that are compressed from the uncompressed videos.

The video transmitter 3032 in the editing system 303 also converts the HD-SDI signals 3030 into the IP packet streams 3033 having uncompressed videos compliant with the SMPTE2022-6, and transmits the converted IP packet streams to the L2/L3 switch 310 via the 10 GbE 3031. In conjunction with that, the video transmitter 3022 compresses videos in the HD-SDI signals 3030 to 100 Mbps signals according to the JPEG2000 encoding scheme, converts the compressed signals into the IP packet streams 3034 having compressed videos compliant with the SMPTE2022-2, and transmits the converted IP packet streams the to the L2/L3 switch 310 via the 1 GbE 3032. That is, in the same way as the case of receiving the videos from the external IP network 301, the L2/L3 switch 310 receives from the recording studio 302 and the editing system 303, both of the IP packet streams 3033 having uncompressed videos and the IP packet streams 3044 having compressed signals with 100 Mbps that are compressed from the uncompressed videos.

Respective IP packet streams having uncompressed videos and respective IP packet streams having compressed videos have different destination IP addresses, different destination MAC addresses, or different VLAN IDs. Even in the case that the destination IP addresses and the destination MAC addresses are set with multicast addresses not unicast addresses, respective IP packet streams are set with different addresses or different VLAN IDs.

The L2/L3 switch 310 identifies the received destination IP addresses, the received destination MAC addresses, or the received VLAN IDs, and selects any of the sending system 304, the archiving system 305, the editing system 306 and the IP-based monitoring system 32 to output the IP packet streams to the selected one. The L2/L3 switch 310 selects the IP packet streams 3123 to 3125 having uncompressed videos for the sending system 304, the archiving system 305, and the editing system 306 respectively, and outputs the selected IP packet streams to the 10 GbE 3101 to 3103 corresponding to the respective systems. Further, the L2/L3 switch 310 selects a series of IP packet streams 3129, and outputs the selected series of IP packet streams to the 10 GbE 3104 corresponding to the IP-based monitoring system 32.

The video transmitter 3042 converts the IP packet streams 3123 having uncompressed videos transmitted to the sending system 304 into the HD-SDI signals 3041 for use in the sending system 304. The video transmitter 3042 also compresses videos in the converted HD-SDI signals 3041 to 100 Mbps signals according to the JPEG2000 encoding scheme for videos to be monitored in the sending system 304, converts the compressed signals into the IP packet streams 3126 having compressed videos compliant with the SMPTE2022-2, and re-transmits the converted IP packet streams to the L2/L3 switch 310 via the 10 GbE 3101. The IP packet streams 3126 having compressed videos re-transmitted to the L2/L3 switch 310 are outputted to the IP-based monitoring system 32 as apart of the series of IP packet streams 3129 having compressed videos.

The video transmitter 3052 also converts the IP packet streams 3124 having uncompressed videos transmitted to the archiving system 305 into the HD-SDI signals 3051 for use in the archiving system 305. The video transmitter 3052 also compresses videos in the converted HD-SDI signals 3051 to 100 Mbps signals according to the JPEG2000 encoding scheme for videos to be monitored in the archiving system 305, converts the compressed signals into the IP packet streams 3127 having compressed videos compliant with the SMPTE2022-2, and re-transmits the converted IP packet streams to the L2/L3 switch 310 via the 10 GbE 3102. The IP packet streams 3127 having compressed videos re-transmitted to the L2/L3 switch 310 are outputted to the IP-based monitoring system 32 as a part of the series of IP packet streams 3129 having compressed videos.

The video transmitter 3062 also converts the IP packet streams 3125 having uncompressed videos transmitted to the editing system 306 into the HD-SDI signals 3062 for use in the editing system 306. The video transmitter 3062 also compresses videos in the converted HD-SDI signals 3061 to 100 Mbps signals according to the JPEG2000 encoding scheme for videos to be monitored in the editing system 306, converts the compressed signals into the IP packet streams 3128 having compressed videos compliant with the SMPTE2022-2, and re-transmits the converted IP packet streams to the L2/L3 switch 310 via the 10 GbE 3103. The IP packet streams 3128 having compressed videos re-transmitted to the L2/L3 switch 310 are outputted to the IP-based monitoring system 32 as apart of the series of IP packet streams 3129 of compressed videos.

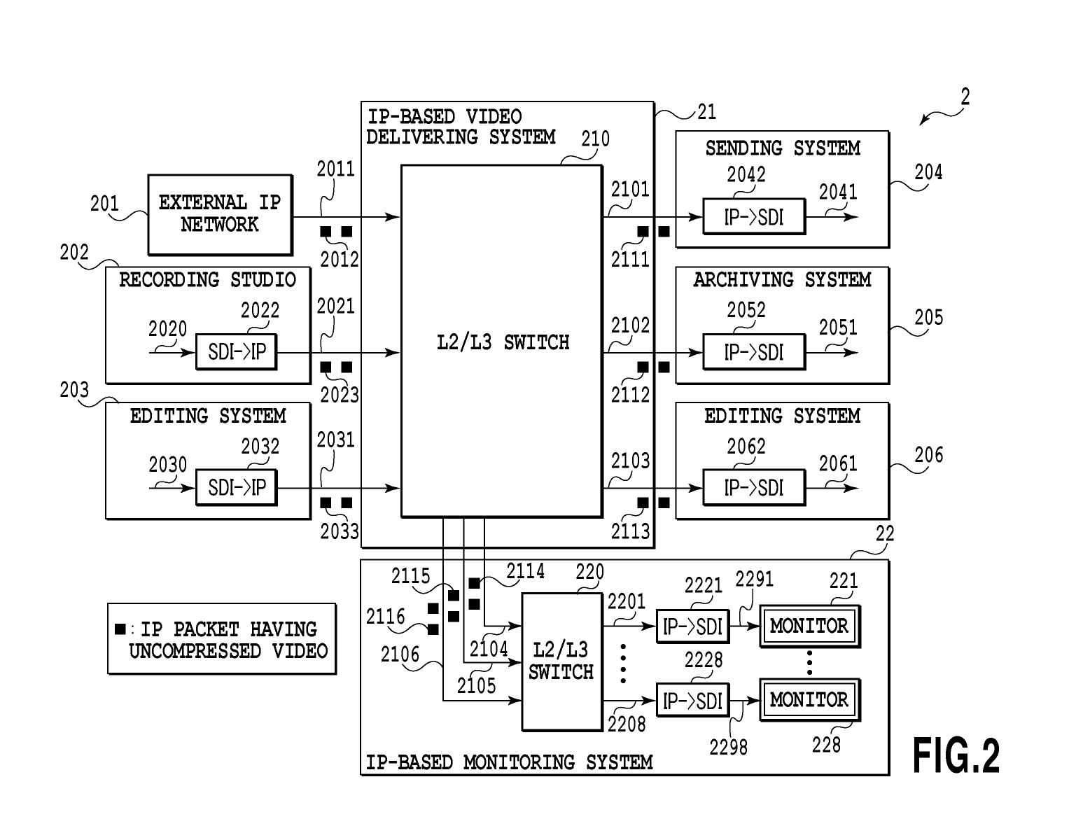

That is, the system illustrated in FIG. 3 delivers to the sending system 304, the archiving system 305 and the editing system 306, videos with image quality equivalent to those delivered in the system illustrated in FIG. 2, and delivers compressed videos with lower bit rate to the IP-based monitoring system 32.

In the IP-based monitoring system 32, the L2/L3 switch 320 selects IP packets having videos to be monitored on the monitors 321 to 328 among the IP packet streams having compressed videos inputted from the 10 GbE 3104, and outputs the selected IP packets to the 1 GbEs 3201 to 3208 respectively. The decoders 3221 to 3228 decode according to the JPEG2000 encoding scheme and convert into the HD-SDI signals 3231 to 3238 respectively, the IP packet streams outputted to the 1GbEs 3201 to 3208 by the L2/L3 switch 320, and the monitors 321 to 328 display the converted HD-SDI signals respectively. With respect to a device having functions comprised in the decoders 3221 to 3228, a plurality of devices have been already commercialized as of 2013, such as the MD8000 from MEDIA LINKS Co., Ltd.

As described above, the broadcasting system illustrated in FIG. 3 delivers uncompressed videos to systems requiring videos with high quality, and delivers compressed videos with low bit rate to the monitoring system, thereby achieving a system using inexpensive GbEs (1 GbE used in the present embodiment). Therefore, costs required for the L2/L3 switch used, cabling costs and wiring costs in the monitoring system can be reduced comparing to the system illustrated in FIG. 2.

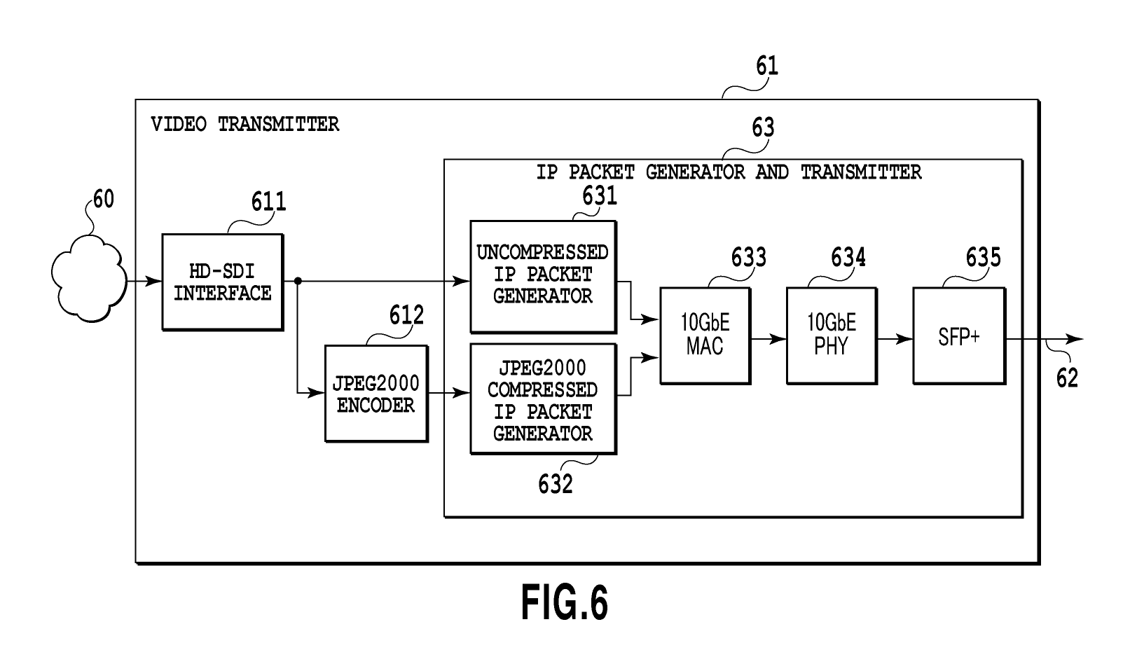

FIG. 6 is a block diagram showing an exemplary structure of the video transmitter 3022 (referred to as video transmitter 61 in FIG. 6) used in the monitoring system illustrated in FIG. 3. The video transmitter 61 illustrated in FIG. 6 includes an HD-SDI interface 611 configured to receive HD-SDI signals 60, a JPEG2000 encoder 612 configured to encode the HD-SDI signals 60, and an IP packet generator and transmitter 63. The IP packet generator and transmitter 63 includes an uncompressed IP packet generator 631 configured to generate IP packet streams having uncompressed videos compliant with the SMPTE2022-6, a JPEG2000 compressed IP packet generator 632 configured to generate IP packet streams having JPEG2000 compressed videos compliant with the SMPTE2022-2, a 10 GbE MAC control circuit 633 configured to control a 10 GbE MAC sublayer, a 10 GbE PHY control circuit 634 configured to control a PHY layer, and an SFP+optical module 635 connected to a 10 GbE 62.

The HD-SDI interface 611 receives the HD-SDI signals 60 inputted into the video transmitter 61. Data received by the HD-SDI interface 611 is transmitted to the uncompressed IP packet generator 631 and the JPEG2000 encoder 612. The uncompressed IP packet generator 631 IP-packetizes data from the HD-SDI interface 611 to generate IP packet streams in a format compliant with the SMPTE2022-6 and illustrated in FIG. 4, and transmits the generated IP packet streams to the 10 GbE MAC control circuit 633. The JPEG2000 encoder 612 compresses video data from the HD-SDI interface 611 according to the JPEG2000 encoding scheme, and transmits streams having the compressed videos to the JPEG2000 compressed IP packet generator 632. The JPEG2000 compressed IP packet generator 632 IP-packetizes streams having compressed videos from the JPEG2000 encoder 612 to generate IP packet stream in a format compliant with the SMPTE2022-2 and illustrated in FIG. 5, and transmits the generated IP packet streams to the 10 GbE MAC control circuit 633. The 10 GbE MAC control circuit 633 transmits to the 10 GbE 62 via the 10 GbE PHY control circuit 634 and the SFP+optical module 635, the IP packet streams received from the uncompressed IP packet generator 631 and the JPEG2000 compressed IP packet generator 632.

As described above, according to the video transmitter 61 of embodiment illustrated in FIG. 6, the IP packet streams having uncompressed videos compliant with the SMPTE2022-6 and the IP packet streams having compressed videos compliant with the SMPTE2022-2 can be generated from the HD-SDI signals in parallel, and can be transmitted to the 10 GbEs. That is, it can achieve the video transmitters 3022 and 3032 illustrated in FIG. 3.

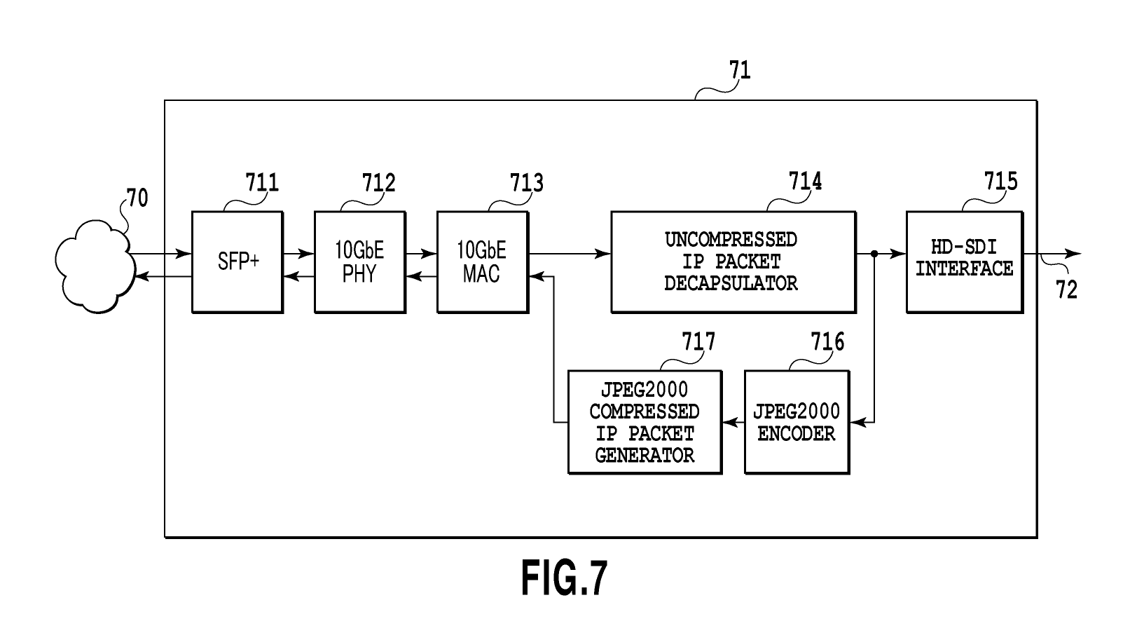

FIG. 7 is a block diagram showing an exemplary structure of the video transmitters 3042, 3052 and 3062 (referred to as video transmitter 71 in FIG. 7) used in the monitoring system illustrated in FIG. 3. The video transmitter 71 illustrated in FIG. 7 includes an SFP+optical module 711 connected to a 10 GbE 70, a 10 GbE PHY control circuit 712 connected to the SFP+optical module 711, and a 10 GbE MAC control circuit 713 connected to the 10 GbE PHY control circuit 712. The video transmitter 71 also includes an uncompressed IP packet decapsulator 714 connected to the 10 GbE MAC control circuit 713, and an HD-SDI interface 715 connected to the uncompressed IP packet decapsulator 714. The video transmitter 71 further includes a JPEG2000 encoder 716 connected to the uncompressed IP packet decapsulator 714, and a JPEG2000 compressed IP packet generator 717 connected between the JPEG2000 encoder 716 and the 10 GbE MAC control circuit 713.

The SFP+optical module 711 receives IP packet streams having uncompressed videos inputted into the video transmitter 71. The IP packet streams having uncompressed videos received by the SFP+optical module 711 are transmitted to the uncompressed IP packet decapsulator 714 via the 10 GbE PHY control circuit 712 and the 10 GbE MAC control circuit 713. The uncompressed IP packet decapsulator 714 depacketizes the IP packet streams having uncompressed videos to convert the depacketized IP packet streams into the HD-SDI signals. The HD-SDI signals depacketized by the uncompressed IP packet decapsulator 714 are outputted as an HD-SDI signal to outside the system via the HD-SDI interface 715.

The video transmitter 71 can also generate videos to be monitored used in facilities such as the sending system, archiving system and editing system in which the video transmitters 71 are placed respectively. The HD-SDI signals outputted from the uncompressed IP packet decapsulator 714 are outputted to the JPEG2000 encoder 716 for being monitored. The JPEG2000 encoder 716 compresses video data from the uncompressed IP packet decapsulator 714 according to the JPEG2000 encoding scheme, and transmits streams having compressed videos to the JPEG2000 compressed IP packet generator 717. The JPEG2000 compressed IP packet generator 717 IP-packetizes streams having compressed videos from the JPEG2000 encoder 716 to generate IP packet streams in a format compliant with the SMPTE2022-2 and illustrated in FIG. 5, and transmits the generated IP packet streams to the 10 GbE MAC control circuit 713. The 10 GbE MAC control circuit 713 transmits to the 10 GbE 70 via the 10 GbE PHY control circuit 712 and the SFP+optical module 711, the IP packet streams received from the JPEG2000 compressed IP packet generator 717.

As described above, according to the video transmitter 71 of embodiment illustrated in FIG. 7, the IP packet streams having compressed videos compliant with the SMPTE2022-2 can be generated from the HD-SDI signals generated by the video transmitter 71, in conjunction with generating the HD-SDI signals from the IP packet streams having uncompressed videos received from the 10 GbE and compliant with the SMPTE2022-6, and they can be transmitted to the 10 GbEs. That is, it can achieve the video transmitters 3042, 3052 and 3062 illustrated in FIG. 3.

Although the present embodiments employ the JPEG2000 scheme as a compression encoding scheme and bit rate with 100 Mbps as a bit rate for compressed video, the embodiments can employ other encoding scheme such as H.264 and HEVC, and other bit rates. Further, although the above embodiments employ an HD-SDI signal as an uncompressed video signal, the present invention can be applied to a video signal in other format such as 3G-SDI and SD-SDI.

Further, it is apparent that the IGMP and PIM protocols can be used as a protocol for switching in the L2/L3 switch illustrated in FIGS. 2 and 3, and a static entry can be generated and controlled in a MAC address table, a routing table and a VLAN table in the switch.

In the present embodiment illustrated in FIG. 3, the external IP network 301, the recording studio 302 and the editing system 303 are connected to the L2/L3 switch 310 as a system for transmitting IP packet streams to the L2/L3 switch 310. However, the external IP network 301, the recording studio 302 and the editing system 303 are only shown as an example. The present invention includes any system for transmitting IP packet streams having compressed videos and IP packet streams having uncompressed videos to the L2/L3 switch 310, and never limit to the system illustrated in FIG. 3. For example, the video transmitter 61 illustrated in FIG. 6 may be set and any camera may be connected to the video transmitter 61 in a sports stadium, and the video transmitter 61 and the L2/L3 switch 310 may be connected to the 10 GbE. Further, for example the video transmitter 61 illustrated in FIG. 6 may be set in other external broadcast station other than the broadcast station in which the IP-based video delivering system 31 is set, and the video transmitter 61 and the L2/L3 switch 310 may be connected to the 10 GbE.

Further, in the present embodiment illustrated in FIG. 3, the sending system 304, archiving system 305, and the editing system 306 are connected to the L2/L3 switch 310 as a system for transmitting IP packet streams having uncompressed videos from the L2/L3 switch 310. However, the sending system 304, archiving system 305, and the editing system 306 are only shown as an example in FIG. 3. The present invention includes any system for transmitting IP packet streams having uncompressed videos from the L2/L3 switch 310, and never limit to the system illustrated in FIG. 3. For example, the L2/L3 switch 310 may be connected to the external IP network directly via the 10 GbE.

In this case, the IP packet streams having compressed videos and the IP packet streams having uncompressed videos are to be transmitted from the video transmitter 61 to the L2/L3 switch 310. The L2/L3 switch 310 transmits the IP packet streams having compressed videos to the IP-based monitoring system 32, and transmits the IP packet streams having uncompressed videos to the sending system and the editing system etc., and the external IP network respectively.

In the present embodiment illustrated in FIG. 3, the L2/L3 switch 320 selects IP packet streams having videos to be displayed on the monitors 321 to 328 among the IP packet streams having compressed videos from the L2/L3 switch 310, and outputs the selected IP packet streams to the 1 GbEs 3201 to 3208 respectively in the IP-based monitoring system 32. However, the L2/L3 switch 320 may be omitted, and the L2/L3 switch 310 may selects directly streams having videos to be displayed on the monitors 221 to 228 among the IP packet streams having compressed videos, and output the selected streams to the 1 GbEs 3201 to 3208 respectively.

Further, the present embodiments describe the case of transmitting videos only, and the video transmitter may compress audio data in the uncompressed video signals according to the AAC scheme and AC3 scheme etc., to generate IP packet streams, and transmits the generated IP packet stream to the monitoring system, thereby reducing costs for the monitoring system as in the case of transmitting video data.

1.-6. (canceled)

7. A method implemented by a broadcasting system comprising:
receiving uncompressed video signals;
IP-packetizing the uncompressed video signals to generate first IP packet streams having uncompressed videos;
compress the uncompressed video signals to generate compressed video data;
IP-packetizing the compressed video data to generate second IP packet streams having compressed videos;
transmitting the first IP packet streams to a video transmitter;
decoding the second IP packet streams to generate first video signals; and
displaying the first video signals on a monitor.

8. The method according to claim 7 further comprising:
receiving from the video transmitter, third IP packet streams having compressed videos corresponding to the first IP packet streams; and
decoding the third IP packet streams to generate second video signals; and
displaying the second video signals on the monitor.

9. A method implemented by a broadcasting system comprising:
receiving first IP packet streams having uncompressed video signals;
converting the first IP packet streams into video signals:
compress the video signals to generate second IP packet streams having compressed videos;
transmitting the first IP packet streams to a video transmitter;
decoding the second IP packet streams to generate first video signals; and
displaying the first video signals on a monitor.

10. The method according to claim 9 further comprising:
receiving from the video transmitter, third IP packet streams having compressed videos corresponding to the first IP packet streams; and
decoding the third IP packet streams to generate second video signals; and
displaying the second video signals on the monitor.

11. A broadcasting system comprising a switch, a first video transmitter, a decoder and a monitor,
wherein the first video transmitter is configured to:
receive uncompressed video signals;
IP-packetize the uncompressed video signals to generate first IP packet streams having uncompressed videos and transmit the first IP packet streams to the switch;
compress the uncompressed video signals to generate compressed video data; and
IP-packetize the compressed video data to generate second IP packet streams having compressed videos and transmit the second IP packet streams to the switch,
wherein the switch is configured to:
transmit to a second video transmitter, the first IP packet streams transmitted by the first video transmitter; and
transmit to the decoder, the second IP packet streams transmitted by the first video transmitter, and
wherein the decoder is configured to:
decode the second IP packet streams transmitted by the switch to generate to a first video signals; and
display the first video signals on the monitor.

12. The broadcasting system according to claim 11, wherein the switch is further configured to
receive from the second video transmitter, third IP packet streams having compressed videos corresponding to the first IP packet streams, and transmit the third IP packet streams to the decoder, and
wherein the decoder is further configured to decode the third IP packet streams transmitted by the switch to generate second video signals, and display the second video signals on the monitor.
